(19) United States
(12) Patent Application Publication
(10) Pub. No.: US 2026/0204054 A1
(43) Pub. Date: Jul. 16, 2026

(54) IMAGE PROCESSING SYSTEM FOR ENSURING BALANCE BETWEEN CONCEALMENT AND IDENTIFIABILITY

(71) Applicant: IDIS CO., LTD., Daejeon (KR)

(72) Inventors: Chul KIM, Seongnam-si (KR); Dong Hyeong SEO, Seoul (KR)

(73) Assignee: IDIS CO., LTD., Daejeon (KR)

(21) Appl. No.: 19/315,568

(22) Filed: Aug. 31, 2025

(30) Foreign Application Priority Data
Jan. 10, 2025 (KR) 10-2025-0004033

(51) Int. Cl. G06V 10/82; G06F 21/62; G06T 7/11

(52) U.S. Cl. CPC G06V 10/82; G06F 21/6245; G06T 7/11; G06V 2201/07

(57) ABSTRACT

An image processing system for ensuring a balance between concealment and identifiability, which ensures a balance between concealment and identifiability by fusing a heatmap-based object recognition method that has relatively accurate object recognition and excellent concealment with an artificial intelligence (AI)-based object recognition method that has relatively excellent identifiability is provided.

### CROSS-REFERENCE TO RELATED APPLICATION(S)

This application claims priority from Korean Patent Application No. 10-2025-0004033, filed on January 10, 2025, in the Korean Intellectual Property Office, the disclosure of which is incorporated herein by reference in its entirety.

### BACKGROUND

### 1. Field

The following description relates to an image masking processing technology for concealing personal identifiable information areas, such as individual faces, from a security processing target image to protect personal information, and more particularly, to an image processing system capable of ensuring a balance between concealment and identifiability.

### 2.Description of Related Art

In closed-circuit television (CCTV) systems and the like, for personal information protection, personal identifiable information areas such as individual faces are subjected to masking processing (mosaic processing, etc.) in images captured by cameras to conceal the personal identifiable information areas, thereby preventing others from identifying individuals in the images and ensuring protection of personal information.

Representative image masking processing technologies for protecting such personal information include a method of performing processing on object areas detected through heatmap-based object recognition, and a method of performing processing on object areas detected through artificial intelligence (AI)-based object recognition.

In the method of performing processing on object areas detected through heatmap-based object recognition, a security processing target image is divided into a plurality of areas, the probability of a masking target object being present in each area is calculated to detect masking target objects, and areas in which masking target objects are detected are masked to protect personal information.

Meanwhile, in the method of performing masking processing on object areas detected through AI-based object recognition, masking target objects are detected from a security processing target image using an AI model, and areas in which masking target objects are detected are masked to protect personal information.

However, the method of performing masking processing on object areas detected through heatmap-based object recognition and the method of performing masking processing on object areas detected through AI-based object recognition exhibit a trade-off between concealment and identifiability.

In the method of performing masking processing on object areas detected through heatmap-based object recognition, objects are recognized by calculating the probability of object presence, which enables accurate object recognition. In addition, since masking is performed in large segmented area units, concealment is excellent, but identifiability is relatively poor because parts that do not require concealing may also be concealed, making it difficult to accurately determine situations from images.

In comparison, in the method of performing masking processing on object areas detected through AI-based object recognition, the accuracy of object recognition is relatively low due to significant object recognition variations depending on the training level of the AI model, and since only recognized object parts are masked, concealment is relatively poor, but since parts that do not require concealing are not concealed, identifiability is relatively excellent, making it possible to accurately determine situations from images.

Therefore, the present inventor has conducted research on an improved image processing technology that ensures a balance between concealment and identifiability by fusing the heatmap-based object recognition method, which has relatively accurate object recognition and excellent concealment, with the AI-based object recognition method, which has relatively excellent identifiability.

### RELATED ART DOCUMENTS

(Patent Document 1) Korean Laid-Open Patent Publication No. 10-2021-0013252 (Publishing date: February 3, 2021)

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to an image processing system capable of ensuring a balance between concealment and identifiability by fusing a heatmap-based object recognition method, which has relatively accurate object recognition and excellent concealment, with an AI-based object recognition method, which has relatively excellent identifiability.

In one general aspect, an image processing system for ensuring a balance between concealment and identifiability includes: a security image processing device that includes: non-volatile memory storing execution code of a security image processing program and associated data; and a processor configured to execute the execution code of the security image processing program stored in the non-volatile memory.

The security image processing program may include: a heatmap-based object detector configured to divide a security processing target image into a plurality of areas, calculate a probability of a masking target object being present in each area to detect an area including the masking target object, and output information about a first area including the masking target object; and an artificial intelligence (AI)-based object detector configured to detect a masking target object from the security processing target image using an AI model for object detection and output information about a second area in which the masking target object is detected.

In another general aspect, the heatmap-based object detector may include: an area divider configured to divide the security processing target image into a plurality of areas having a predetermined size; a heatmap processor configured to calculate the probability of the masking target object being present in each area divided by the area divider; and an object area detector configured to detect an area in which the masking target object is present based on the probability calculated by the heatmap processor for each area.

In another general aspect, an area division size of the area divider may be adjustable according to settings.

In another general aspect, the AI model for object detection may be trained and updated.

In another general aspect, the image processing system may further include: a masking processing device configured to fuse the information about the first area, in which the masking target object is detected, output from the heatmap-based object detector and the information about the second area, in which the masking target object is detected, output from the AI-based object detector to determine a masking area, and perform masking processing on the determined masking area.

In another general aspect, the masking processing device may perform masking processing on the second area in the security processing target image using a masking processing method different from a masking processing method performed on the first area when the second area is included in the first area.

In another general aspect, the masking processing device may additionally perform masking processing on an area in which the probability of a masking target object being present exceeds a threshold in the security processing target image among areas belonging to the first area and not the second area.

In another general aspect, the masking processing device may perform different masking processing on the first area and the second area when the second area is only partially included in the first area or the second area is not included in the first area, while performing masking processing on a region in which the first area and the second area overlap using a masking method performed on the second area.

In another general aspect, the masking processing device may perform masking processing on the second area when only the second area is present and the first area is not present.

In another general aspect, the masking processing device may perform masking processing on the first area in the security processing target image when the second area is not present and only the first area is present.

In another general aspect, the masking processing device may adjust a mosaic intensity according to characteristics of the masking area.

In another general aspect, the masking processing device may adjust a mosaic intensity by adjusting a mosaic size to be smaller as a size of the masking area decreases.

In another general aspect, the masking processing device may be implemented physically as the same device as the security image processing device while being logically separated from the security image processing device.

In another general aspect, the masking processing device may be implemented as a physically different device from the security image processing device.

In another general aspect, the image processing system may further include at least one camera configured to capture the security processing target image.

In another general aspect, the camera may be a closed-circuit television (CCTV) camera or an Internet protocol (IP) camera connected to the security image processing device via a wired or wireless network.

Other features and aspects will be apparent from the following detailed description, the drawings, and the claims.

### BRIEF DESCRIPTION OF THE DRAWINGS

FIG. 1 is a schematic diagram of an image processing system for ensuring a balance between concealment and identifiability according to the present invention.

FIG. 2 is a block diagram illustrating the configuration of a security image processing device of an image processing system for ensuring a balance between concealment and identifiability according to an embodiment of the present invention.

FIG. 3 is a block diagram illustrating the configuration of a security image processing program of an image processing system for ensuring a balance between concealment and identifiability according to an embodiment of the present invention.

FIGS. 4A and 4B are diagrams illustrating areas in which masking target objects are detected by a heatmap-based object detector and an AI-based object detector of an image processing system for ensuring a balance between concealment and identifiability according to the present invention.

FIG. 5 is a block diagram illustrating the configuration of a heatmap-based object detector of an image processing system for ensuring a balance between concealment and identifiability according to an embodiment of the present invention.

FIG. 6 is a diagram illustrating an example in which, when a second area is included in a first area, the second area is masked differently from the first area in a security processing target image by a masking processing device of an image processing system for ensuring a balance between concealment and identifiability according to the present invention.

FIG. 7 is a diagram illustrating an example in which, among areas belonging to a first area and not a second area, areas in which the probability of a masking target object being present exceeds a threshold are additionally masked in a security processing target image by a masking processing device of an image processing system for ensuring a balance between concealment and identifiability according to the present invention.

FIG. 8 is a diagram illustrating an example in which, when a second area is partially included in a first area, a portion in which the first area and the second area overlap is masked using a second area masking method by a masking processing device of an image processing system for ensuring a balance between concealment and identifiability according to the present invention.

FIG. 9 is a diagram illustrating an example in which, when only a second area is present and a first area is not present, the second area is masked by a masking processing device of an image processing system for ensuring a balance between concealment and identifiability according to the present invention.

FIG. 10 is a diagram illustrating an example in which, when a second area is not present and only a first area is present, the first area is processed in a security processing target image by a masking processing device of an image processing system for ensuring a balance between concealment and identifiability according to the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The foregoing and additional aspects are embodied in the following embodiments described with reference to the accompanying drawings. Unless otherwise stated or unless inconsistent with one another, the components of the respective embodiments may be combined in various ways within a single embodiment or across different embodiments. In accordance with the principle that an inventor may define terms as appropriate to best describe their invention, the terms used in the present specification and claims shall be interpreted in a manner consistent with the descriptions or the disclosed technical ideas.

The blocks referred to as “circuits” in the present specification may be implemented as hardware such as dedicated semiconductors, gate arrays, field-programmable gate arrays (FPGAs), or a portion thereof. One or more blocks may be implemented in a single piece of hardware. Alternatively, such blocks may be implemented in software as information processing devices in which computing elements execute program instructions stored in memory elements. Multiple blocks may be implemented as parts of a single program executed on a common computing element.

In another example, such blocks may be implemented in a hybrid form, in which part of each block is realized in hardware and part in software. In software-based implementations, the computing element may include or be a combination of a digital signal processor (DSP), an application-specific processor, an artificial intelligence (AI) processing engine, an AI-specific processor, or a graphics processing unit (GPU), among other possible computing resources

Hereinafter, preferred embodiments of the present invention will be described in detail with reference to the accompanying drawings so that those skilled in the art may readily understand and reproduce the invention.

Although specific embodiments are illustrated in the drawings and described in detail below, such illustrations and descriptions are not intended to limit the various embodiments of the present invention to any particular form.

In describing the present invention, detailed explanations of known functions or configurations that may unnecessarily obscure the essence of the embodiments of the present invention will be omitted.

When it is stated that one component is “connected” or “coupled” to another component, it should be understood that the component may be directly connected or coupled to the other component or indirectly connected or coupled via another component.

On the other hand, when it is stated that one component is “directly connected” or “directly coupled” to another component, it should be understood that no other components are present between them.

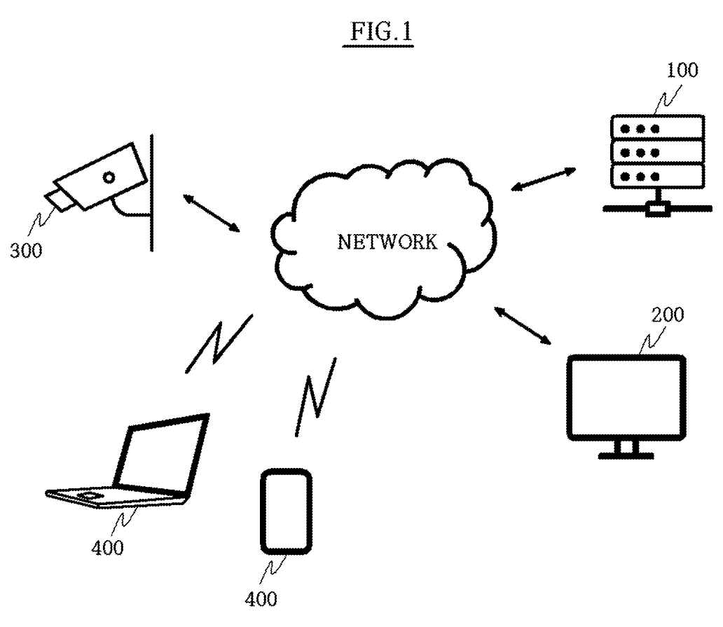

FIG. 1 is a schematic diagram of an image processing system for ensuring a balance between concealment and identifiability according to the present invention. As shown in FIG. 1, the image processing system for ensuring a balance between concealment and identifiability according to the present invention may be implemented with a security image processing device 100, a masking processing device 200, and at least one camera 300 connected via a wired or wireless network.

The security image processing device 100 detects masking target objects from security processing target images using both a heatmap-based object detection method and an artificial intelligence (AI)-based object detection method, and outputs area information of the detected masking target objects for the heatmap-based object detection method and the AI-based object detection method.

The masking processing device 200 fuses the area information output by the security image processing device 100 to determine a masking area and performs masking processing on the determined masking area in a security processing target image to protect personal information.

The security processing target image with the masking area masked to protect personal information is transmitted to an image playback device 400, such as a user mobile terminal, a personal computer (PC), and the like that has requested the image, and then played back.

In this case, the masking processing device 200 may be physically implemented as the same device while being separated only logically from the security image processing device 100, or the masking processing device 200 may be implemented as a physically different device from the security image processing device 100.

The at least one camera 300 captures a security processing target image processed by the security image processing device 100. In this case, the camera 300 may be a closed-circuit television (CCTV) camera or an Internet protocol (IP) camera connected to the security image processing device via wired or wireless network, but is not limited thereto.

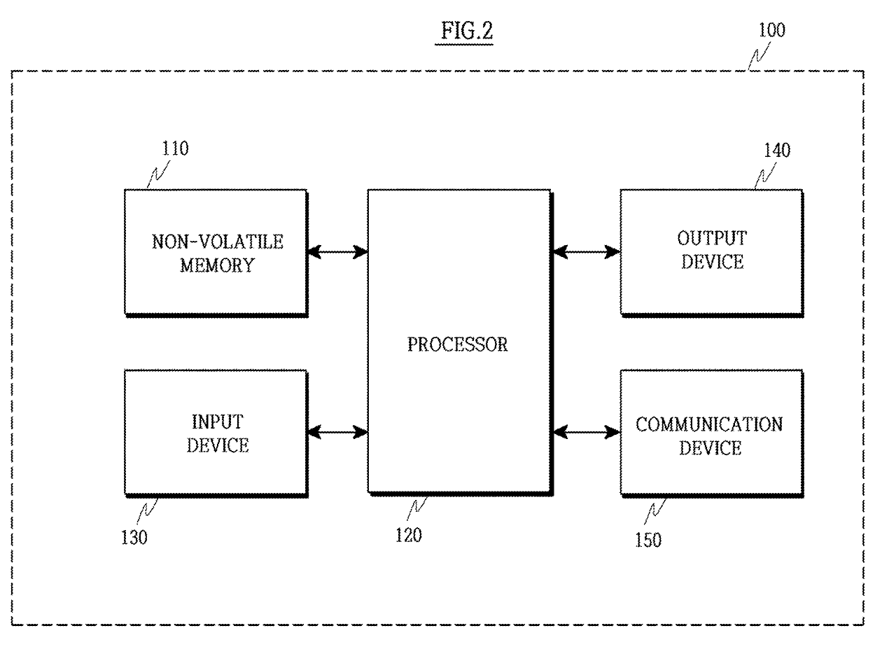

FIG. 2 is a block diagram illustrating the configuration of a security image processing device of an image processing system for ensuring a balance between concealment and identifiability according to an embodiment of the present invention. As shown in FIG. 2, the security image processing device 100 according to the embodiment may include a non-volatile memory 110 for storing information and a processor 120 for processing information.

In addition, the security image processing device 100 may further include an input device 130, such as a keyboard or mouse for user input, an output device 140, such as a display for screen display, and a communication device 150, such as a modem for communication.

The non-volatile memory 110 stores execution code of a security image processing program 1000 and associated data. For example, the non-volatile memory 110 may be an electrically erasable programmable ROM (EEPROM), a flash memory, and the like, but is not limited thereto.

The processor 120 executes the execution code of the security image processing program 1000 stored in the non-volatile memory 110. For example, the processor 120 may be implemented as a CPU with a single core or a CPU with multiple cores, but is not limited thereto.

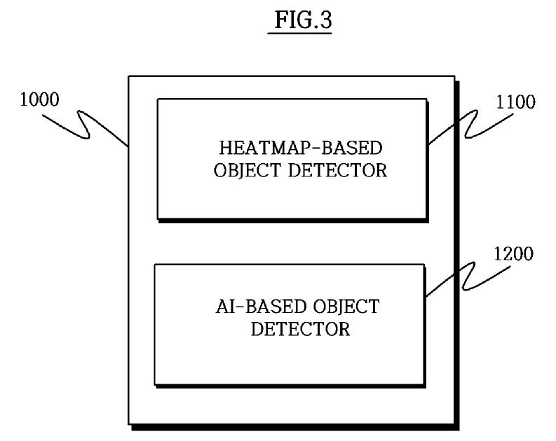

FIG. 3 is a block diagram illustrating the configuration of a security image processing program of an image processing system for ensuring a balance between concealment and identifiability according to an embodiment of the present invention. As shown in FIG. 3, the security image processing program 1000 may include a heatmap-based object detector 1100 that detects objects using a heatmap-based object detection method and an AI-based object detector 1200 that detects objects using an AI-based object detection method.

The heatmap-based object detector 1100 divides a security processing target image into a plurality of areas, calculates a probability of a masking target object being present in each area to detect an area including a masking target object, and outputs information about a first area including the masking target object.

For example, the information about the first area may include image frame information including a frame sequence, coordinate information of a first area in which a masking target object is detected, and object attribute information, such as the type of a masking target object. In this case, the coordinate information of the first area may include starting point coordinates and ending point coordinates of the first area.

The AI-based object detector 1200 detects a masking target object from a security processing target image using an AI model for object detection and outputs information about a second area in which a masking target object is detected.

For example, the information about the second area may include image frame information including a frame sequence, coordinate information of a second area in which a masking target object is detected, and object attribute information, such as the type of a masking target object. In this case, the coordinate information of the second area may include center point coordinates of the second area and horizontal (x-axis) and vertical (y-axis) direction sizes.

Meanwhile, the AI model for object detection may be based on an artificial neural network (ANN) or deep learning, but is not limited thereto.

Meanwhile, the AI model for object detection may be trained and updated through supervised learning, unsupervised learning, or reinforcement learning methods.

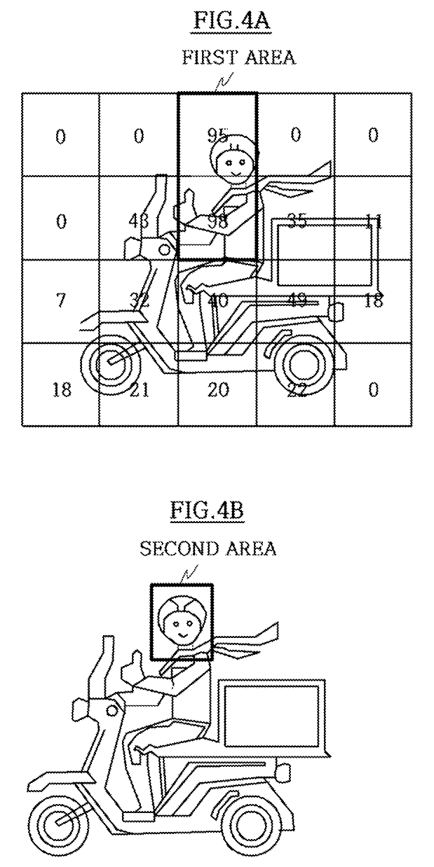

FIGS. 4A and 4B are diagrams illustrating areas in which masking target objects are detected by a heatmap-based object detector and an AI-based object detector of an image processing system for ensuring a balance between concealment and identifiability according to the present invention.

FIG. 4A shows a first area in which a masking target object is detected by the heatmap-based object detector, and it can be seen that even a part of the upper body including the face area of a person, which is the masking target object, is detected.

FIG. 4B shows a second area in which a masking target object is detected by the AI-based object detector, and it can be seen that only the face area of a person, which is the masking target object, is detected.

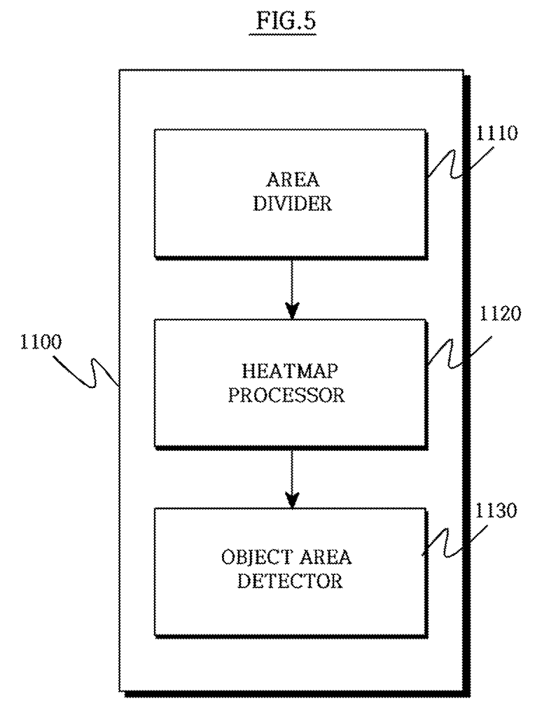

FIG. 5 is a block diagram illustrating the configuration of a heatmap-based object detector of an image processing system for ensuring a balance between concealment and identifiability according to an embodiment of the present invention. As shown in FIG. 5, the heatmap-based object detector 1100 includes an area divider 1110, a heatmap processor 1120, and an object area detector 1130.

The area divider 1110 divides a security processing target image into a plurality of areas having a predetermined size. In this case, the size of the area divided by the area divider 1110 is adjustable according to settings. Referring to FIG. 4A, a security processing target image is divided into a plurality of areas having a predetermined size.

The heatmap processor 1120 calculates the probability of a masking target object being present in each area divided by the area divider 1110. Referring to FIG. 4A, the probability of a masking target object being present is marked in each of the plurality of divided areas with a predetermined size.

The object area detector 1130 detects areas in which masking target objects are present based on the probabilities calculated by the heatmap processor 1120 for each area. Referring to FIG. 4A, it can be seen that two areas (areas marked with thick solid lines) having high probabilities of masking target objects being present among a plurality of divided areas with a predetermined size are detected as areas in which masking target objects are present.

Meanwhile, according to an additional aspect of the invention, the masking processing device 200 may be implemented to fuse the information about the first area in which the masking target object is detected output from the heatmap-based object detector 1100 and the information about the second area in which the masking target object is detected output from the AI-based object detector 1200 to determine a masking area, and perform masking processing on the determined masking area in the security processing target image.

In this case, the masking processing device 200 may be implemented to adjust the mosaic intensity according to characteristics of the masking area. For example, the masking processing device 200 may be implemented to adjust the mosaic intensity by adjusting the mosaic size to be smaller as the size of the masking area decreases.

Meanwhile, when the second area is included in the first area, the masking processing device 200 may be implemented to perform masking processing on the second area in the security processing target image using a masking processing method different from that performed on the first area. For example, the masking processing device 200 may be implemented to apply different masking patterns to the first area and the second area, thereby performing different masking for each area.

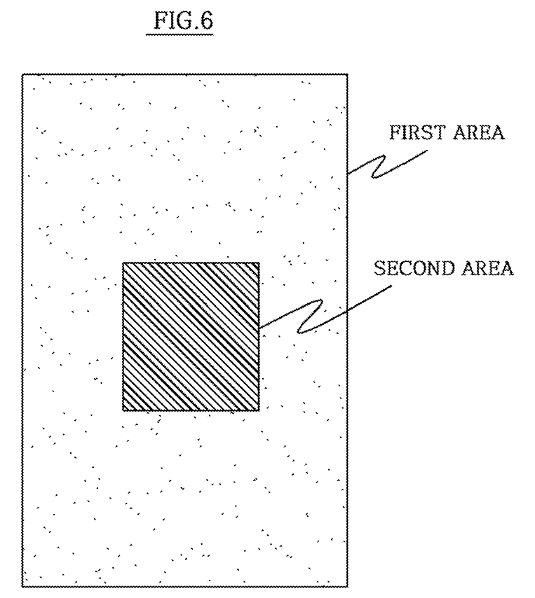

FIG. 6 is a diagram illustrating an example in which, when a second area is included in a first area, the second area is masked differently from the first area in a security processing target image by a masking processing device of an image processing system for ensuring a balance between concealment and identifiability according to the present invention. Referring to FIG. 6, it can be seen that when a second area is included in a first area, the second area is masked with a pattern different from that of the first area in the security processing target image.

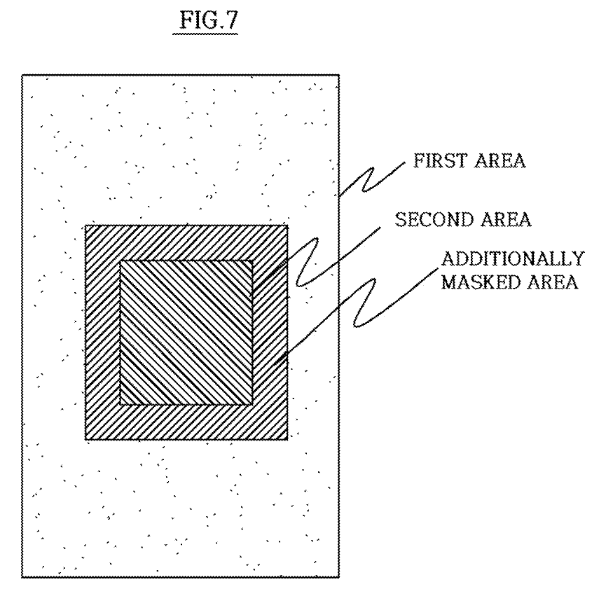

Meanwhile, the masking processing device 200 may be implemented to additionally perform masking processing on areas in which the probability of masking target objects being present exceeds a threshold among areas belonging to the first area and not the second area in the security processing target images. FIG. 7 is a diagram illustrating an example in which, among areas belonging to a first area and not a second area, areas in which the probability of the presence of masking target objects exceeds a threshold are additionally masked in a security processing target image by a masking processing device of an image processing system for ensuring a balance between concealment and identifiability according to the present invention. Referring to FIG. 7, it can be seen that areas in which the probability of masking target objects being present exceeds a threshold are additionally masked among areas belonging to the first area and not the second area.

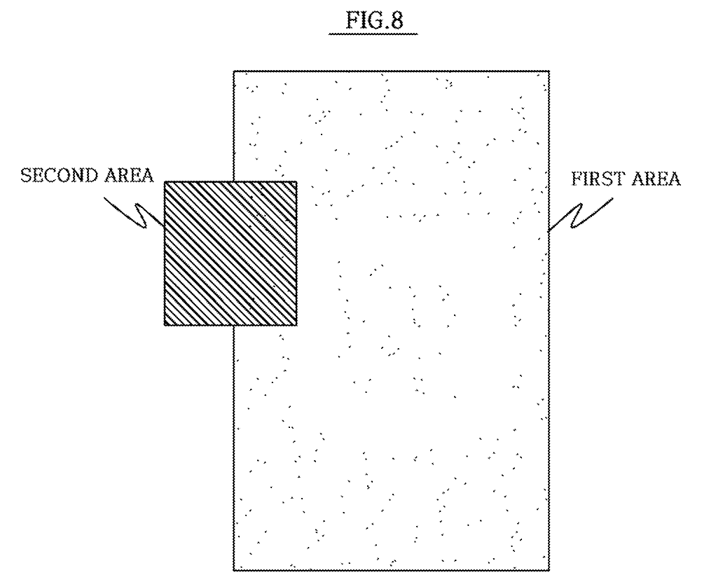

Meanwhile, when the second area is only partially included in the first area or the second area is not included in the first area, the masking processing device 200 may be implemented to perform different masking processing on the first area and the second area, while performing masking processing on a region in which the first area and the second area overlap using a masking method applied to the second area. FIG. 8 is a diagram illustrating an example in which, when a second area is partially included in a first area, a portion in which the first area and the second area overlap is masked using a second area masking method by a masking processing device of an image processing system for ensuring a balance between concealment and identifiability according to the present invention. Referring to FIG. 8, when the second area is partially included in the first area, it can be seen that a region in which the first area and the second area overlap in the security processing target image is masked using the second area masking method.

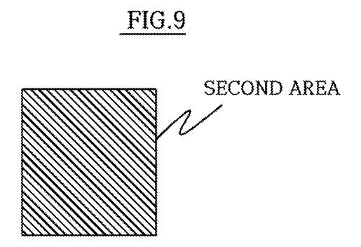

Meanwhile, when only the second area is present and the first area is not present, the masking processing device 200 may be implemented to perform masking processing only on the second area. FIG. 9 is a diagram illustrating an example in which, when only a second area is present and a first area is not present, the second area is masked by a masking processing device of an image processing system for ensuring a balance between concealment and identifiability according to the present invention. Referring to FIG. 9, when only the second area is present and the first area is not present, it can be seen that the second area is masked in the security processing target image.

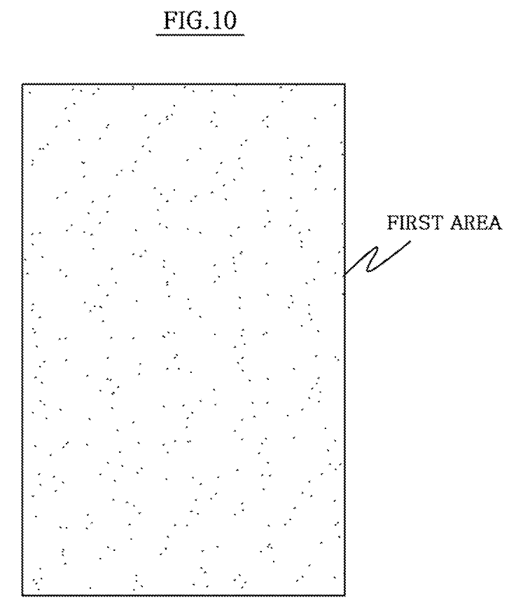

Meanwhile, when the second area is not present and only the first area is present, the masking processing device 200 may be implemented to perform masking processing on the first area in the security processing target images. FIG. 10 is a diagram illustrating an example in which, when a second area is not present and only a first area is present, the first area is processed in a security processing target image by a masking processing device of an image processing system for ensuring a balance between concealment and identifiability according to the present invention. Referring to FIG. 10, it can be seen that, when the second area is not present and only the first area is present, the first area is masked in the security processing target image.

When implemented in this way, the present invention may ensure a balance between concealment and identifiability by fusing the heatmap-based object recognition method, which has relatively accurate object recognition and excellent concealment, with the AI-based object recognition method, which has relatively excellent identifiability, thereby enabling efficient personal information protection for security processing target images.

The various embodiments disclosed in this specification and drawings are merely presented as specific examples for understanding and are not intended to limit the scope of the various embodiments of the present invention.

Therefore, the scope of the various embodiments of the present invention should be interpreted to include all changes or modified forms derived based on the technical ideas of the various embodiments of the present invention in addition to the embodiments described herein within the scope of the various embodiments of the present invention.

The present invention can ensure a balance between concealment and identifiability by fusing a heatmap-based object recognition method, which has relatively accurate object recognition and excellent concealment, with an AI-based object recognition method, which has relatively excellent identifiability, thereby enabling efficient protection of personal information for security processing target images.

### INDUSTRIAL APPLICABILITY

The present invention is industrially applicable in the technical field of image masking processing for concealing personal information areas from security processing target images and its application technology fields.

What is claimed is:

1. An image processing system for ensuring a balance between concealment and identifiability, the image processing system comprising a security image processing device including: non-volatile memory storing execution code of a security image processing program and associated data; and a processor configured to execute the execution code of the security image processing program stored in the non-volatile memory,
wherein the security image processing program includes:
a heatmap-based object detector configured to divide a security processing target image into a plurality of areas, calculate a probability of a masking target object being present in each area to detect an area including the masking target object, and output information about a first area including the masking target object; and
an artificial intelligence (AI)-based object detector configured to detect a masking target object from the security processing target image using an AI model for object detection and output information about a second area in which the masking target object is detected.

2. The image processing system of claim 1, wherein the heatmap-based object detector includes:
an area divider configured to divide the security processing target image into a plurality of areas having a predetermined size;
a heatmap processor configured to calculate the probability of the masking target object being present in each area divided by the area divider; and
an object area detector configured to detect an area in which the masking target object is present based on the probability calculated by the heatmap processor for each area.

3. The image processing system of claim 2, wherein an area division size of the area divider is adjustable according to settings.

4. The image processing system of claim 1, wherein the AI model for object detection is trained and updated.

5. The image processing system of claim 1, further comprising a masking processing device configured to fuse the information about the first area, in which the masking target object is detected, output from the heatmap-based object detector and the information about the second area, in which the masking target object is detected, output from the AI-based object detector to determine a masking area, and perform masking processing on the determined masking area.

6. The image processing system of claim 5, wherein the masking processing device performs masking processing on the second area in the security processing target image using a masking processing method different from a masking processing method performed on the first area when the second area is included in the first area.

7. The image processing system of claim 6, wherein the masking processing device additionally performs masking processing on an area in which the probability of a masking target object being present exceeds a threshold in the security processing target image among areas belonging to the first area and not the second area.

8. The image processing system of claim 5, wherein the masking processing device performs different masking processing on the first area and the second area when the second area is only partially included in the first area or the second area is not included in the first area, while performing masking processing on a region in which the first area and the second area overlap using a masking method performed on the second area.

9. The image processing system of claim 5, wherein the masking processing device performs masking processing on the second area when only the second area is present and the first area is not present.

10. The image processing system of claim 5, wherein the masking processing device performs masking processing on the first area in the security processing target image when the second area is not present and only the first area is present.

11. The image processing system of claim 5, wherein the masking processing device adjusts a mosaic intensity according to characteristics of the masking area.

12. The image processing system of claim 11, wherein the masking processing device adjusts a mosaic intensity by adjusting a mosaic size to be smaller as a size of the masking area decreases.

13. The image processing system of claim 5, wherein the masking processing device is implemented physically as the same device as the security image processing device while being logically separated from the security image processing device.

14. The image processing system of claim 5, wherein the masking processing device is implemented as a physically different device from the security image processing device.

15. The image processing system of claim 5, further comprising at least one camera configured to capture the security processing target image.

16. The image processing system of claim 15, wherein the camera is a closed-circuit television (CCTV) camera or an Internet protocol (IP) camera connected to the security image processing device via a wired or wireless network.
